(19) United States
(12) Patent Application Publication
(10) Pub. No.: US 2006/0245883 A1
(43) Pub. Date: Nov. 2, 2006

(54) Vehicle ramp assembly

(76) Inventors: Yves Fontaine, Montreal (CA); Daniel Frappier, Mascouche (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/102,878

(22) Filed: Apr. 11, 2005

(51) Int. Cl. B60P 1/00

(52) U.S. Cl. 414/537

(57) ABSTRACT

A ramp assembly for use in a vehicle provides access thereto by users having reduced mobility. The ramp assembly comprises a ramp platform displaceable relative to a mounting structure between a retracted position and a deployed position. A drive mechanism is disposed within the mounting structure and operable to displace the ramp platform between the retracted and the deployed positions. The drive mechanism includes at least a drive shaft and a bidirectional motor unit selectively actuable to rotate the drive shaft in a first direction for deploying the ramp platform and a second opposed direction for retracting the ramp platform. The drive mechanism includes a pair of flexible transmission elements each interconnecting the drive shaft with a lateral edge of the ramp platform, for displacement thereof relative to the mounting structure.

### TECHNICAL FIELD

The present invention relates generally to a ramp assembly for a vehicle, and more particularly to a ramp assembly providing access to the vehicle for users having limited mobility.

### BACKGROUND OF THE INVENTION

Improvements continue to be made to ensure that physically challenged people having reduced mobility, such as those confined to wheelchairs for example, have sufficient access to private and public transportation vehicles such as cars and buses. Various ramp and lift designs exist which enable access for such a wheelchair bound person to get into and out of a road vehicle which might otherwise be inaccessible to them. Such ramps and lifts are typically deployed, extending down from the vehicle to the ground to allow the person of limited mobility to enter into the vehicle, and subsequently retracted back into the vehicle once the user is inside. Known lift assemblies generally include mobile platforms which remain substantially level when raised and lowered to transport a wheelchair and occupant between the ground level and a vehicle entry level. Ramp style assemblies typically have an outer end which, when deployed, is lowered to the ground level and an inner end which remains close to the level of the vehicle entry height. Ramp assemblies are generally less bulky than their lift-style counterparts. Nonetheless, many existing ramp and lift designs are quite complex to operate and require considerable stowage space within the vehicle when not deployed.

Wheelchair ramps which are more compact and easier to operate have more recently been developed. U.S. Pat. No. 5,832,555 which issued Nov. 10, 1998 to Saucier et al., for example, provides such a compact wheelchair ramp which can be installed in the floor of a vehicle. However, improvements can be made to known ramps assemblies for vehicles and to this design of Saucier et al. in particular. For instance, the drive mechanism used by Saucier et al. to deploy and retract the ramp platform has proven to be particularly problematic, causing binding of the displaceable ramp platform within the guide assembly and subsequently failure of the entire device. This often results in withdrawal from service of the entire vehicle which, especially in the case of a public transportation vehicle such as a bus, can be very time consuming and costly. This has led many operators of such public transportation vehicles equipped with such ramps to simply deactivate or block them from being able to deploy, thereby rendering their installation in the vehicle redundant. Further, extension of the ramp platform from the vehicle can be dangerous when obstacles might obstruct the clean deployment thereof. If the operator of the ramp assembly fails to notice inanimate objects, such as road curbs or other obstacles, or passengers of the vehicle who may be standing on the ground next to the vehicle in the path of the extending ramp, the ramp assembly can be damaged or, worse still, the passengers can be injured.

There exists therefore a need for an improved vehicle ramp assembly which addresses these and other disadvantages of current means of vehicle access for persons of reduced mobility.

### SUMMARY OF THE INVENTION

It is therefore an object of the present invention to provide an improved vehicle ramp assembly.

Accordingly, in accordance with one aspect of the present invention, there is provided a ramp assembly for use in a vehicle to provide access thereto by users having reduced mobility, the ramp assembly comprising: a ramp platform displaceable relative to a mounting structure adapted for engagement to said vehicle said ramp platform being displaceable between a retracted position wherein said ramp platform is stowed within said mounting structure and a deployed position; and a drive mechanism disposed within said mounting structure and operable to displace said ramp platform between said retracted and said deployed positions, said drive mechanism having at least a drive shaft and a bidirectional motor unit selectively actuable to rotate said drive shaft in a first direction for deploying said ramp platform and a second opposed direction for retracting said ramp platform, said drive mechanism including a pair of flexible transmission elements each interconnecting said drive shaft with a lateral edge of said ramp platform for displacement thereof relative to said mounting structure.

There is also provided, in accordance with another aspect of the present invention, a vehicle having a ramp assembly for providing access thereto by users having reduced mobility, the vehicle having a passenger compartment defining an inner floor and a door providing access to the passenger compartment, the ramp assembly comprising: a mounting structure being disposed within said floor of the vehicle in alignment with said door; a ramp platform displaceable relative to the mounting structure between a retracted position wherein said ramp platform is stowed within said mounting structure and a deployed position extending outwards from said vehicle; and a drive mechanism disposed within said mounting structure, said drive mechanism having a pair of gear driven flexible transmission elements each interconnecting a lateral edge of said ramp platform with a motor unit operable to move said ramp platform relative to said mounting structure between said retracted and said deployed positions.

There is further provided, in accordance with another aspect of the present invention, a ramp assembly for use in a vehicle to provide access thereto by users having reduced mobility, the ramp assembly comprising: a mounting structure adapted for engagement to said vehicle beneath a door thereof; a ramp platform displaceable relative to the mounting structure between a retracted position wherein said ramp platform is stowed within said mounting structure and a deployed position; a drive mechanism disposed within said mounting structure and operable to displace said ramp platform between said retracted and said deployed positions; and an obstacle detection system including a sensing means for detecting deflection of said drive shaft and a control unit in communication with said sensing means which receives output signals therefrom, said control unit being operable to reverse a direction of said drive mechanism when said output signal is above a predetermined threshold limit, wherein said predetermined threshold limit corresponds to an amount of deflection generated in said drive shaft when said ramp platform contacts an obstacle which is obstructing full deployment thereof from said mounting structure.

There is further still provided, in accordance with another aspect of the present invention, a drive mechanism for use with a retractable vehicle ramp assembly which provides access to a vehicle for users having reduced mobility, the drive mechanism comprising at least one drive shaft transversely mountable within the ramp assembly and a bidirectional motor unit selectively actuable to rotate said drive shaft in a first direction for deploying said ramp platform and a second opposed direction for retracting said ramp platform, a pair of drive gears being fixed to the drive shaft proximate opposed lateral ends thereof, and a pair of flexible transmission elements each being driven by one of said drive gears and having a coupling link adapted for engagement with one lateral edge of a ramp platform of said ramp assembly.

Further details of these and other aspects of the present invention will be apparent from the detailed description and figures included below.

### BRIEF DESCRIPTION OF THE DRAWINGS

Reference is now made to the accompanying figures depicting aspects of the present invention, in which:

FIG. 1 is a front quarter perspective view of a bus having a ramp assembly in accordance with an embodiment of the present invention, the ramp assembly being disposed in a retracted position;

FIG. 2 is a partial perspective view of the bus of FIG. 1 showing the ramp assembly in a deployed position for use by a user having limited mobility;

FIG. 3 is a perspective view of the ramp assembly in accordance with an embodiment of the present invention, shown in a deployed position;

FIG. 4 is a perspective view of the ramp assembly of FIG. 3 shown in a retracted position;

FIG. 5 is a perspective view of the ramp assembly of FIG. 4 having outer floor sections and the ramp platform removed and showing an exploded detail of the drive mechanism thereof;

FIG. 6 is a partially exploded perspective view of selected elements of the ramp assembly, showing the ramp and associated elements of the drive mechanism;

FIG. 7 is a perspective view of the ramp of the ramp assembly, showing an exploded portion of the biasing mechanism thereof;

FIG. 8 is a perspective view of the ramp assembly of FIG. 4 having outer floor sections removed and showing an exploded detail of the obstacle detection system thereof;

FIG. 9 is a perspective view of the ramp assembly of FIG. 4 having outer floor sections removed and showing exploded details of the ramp position sensors thereof;

FIG. 10 is a partially exploded perspective view of the ramp assembly of FIG. 4 having at least a rear outer floor section removed, and showing details of the disengageable drive portion of the drive mechanism thereof;

FIG. 11 is a side elevation view of the ramp assembly of FIG. 3, showing a detailed view of the interconnection between the ramp and the drive mechanism;

FIGS. 12a-12c are perspective views of an embodiment of the ramp assembly of the present invention, showing successive steps for manual deployment of the ramp; and

FIGS. 13a-d are perspective views of an embodiment of the ramp assembly of the present invention, showing successive steps for the manual retraction of the ramp.

### DETAILED DESCRIPTION OF THE PREFERRED EMBODIMENT

A vehicle as defined herein is intended to include any passenger vehicle which may be used for transportation and into which a person or persons having reduced mobility (such as those who use wheelchairs for example) such as, but not limited to, buses, automobiles, trains, and the like. While the extending ramp assembly of the present invention may be employed in any such vehicle, it is particular suited for a public transportation vehicle, such as a bus for example, which must accommodate both able bodied users and those having reduced mobility.

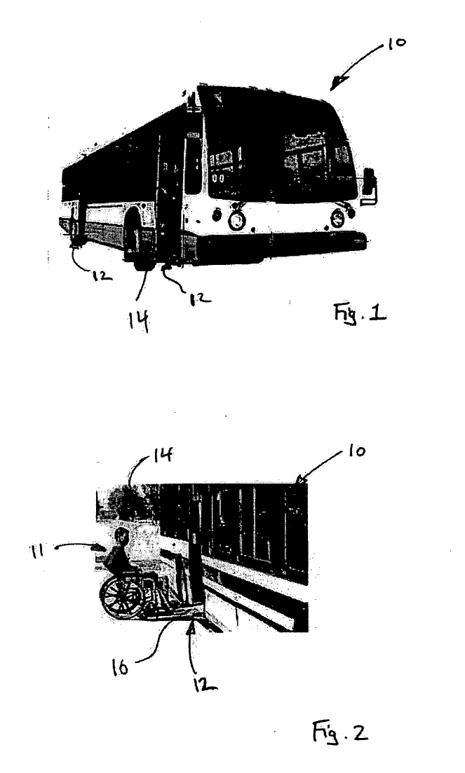

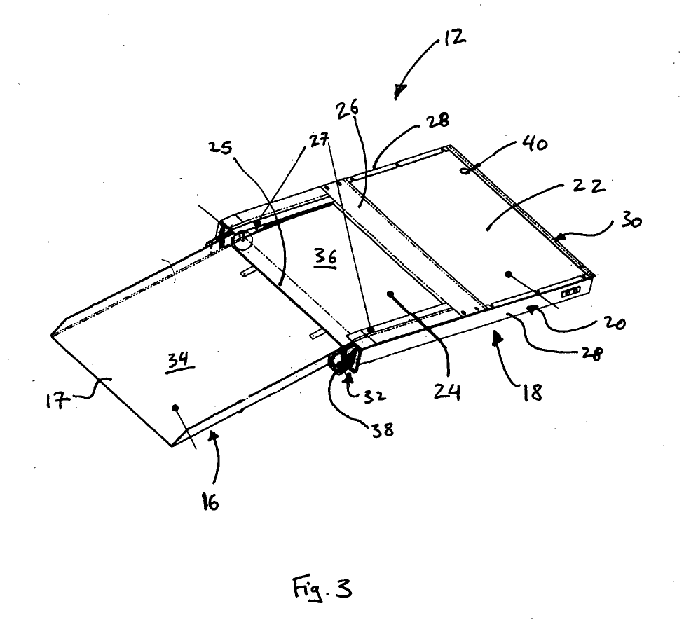

As shown in FIGS. 1 and 2, a bus 10 having at least one ramp assembly 12 in accordance with an embodiment of the present invention is depicted, the ramp assemblies 12 being compact and low profile such that they can be installed within the floor structures of the bus immediately below a access door 14 thereof. The ramp assembly 12 provides an access ramp which can be deployed when required to extend outward from the vehicle down to ground level, such that a person having reduced mobility 11 can enter or exit the vehicle via the angled ramp platform 16 rather than having to negotiate stairs or a step to be able to enter the vehicle. Once the user 11 has entered the vehicle, the ramp platform is retracted back within the vehicle and stowed out of sight. Many city buses include two doors 14 to improve the flow of passengers into and out of the vehicle. The ramp assembly 12 may thus be disposed below one or both doors 14 of the bus 10.

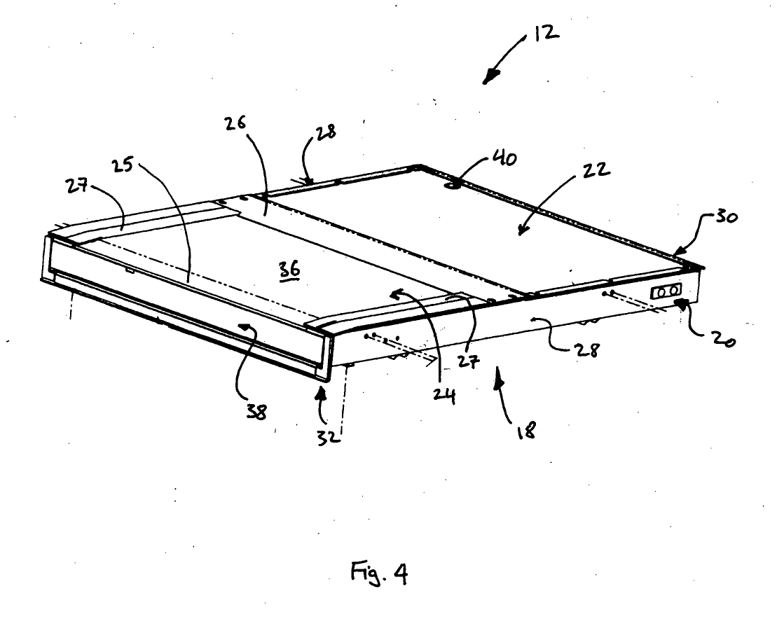

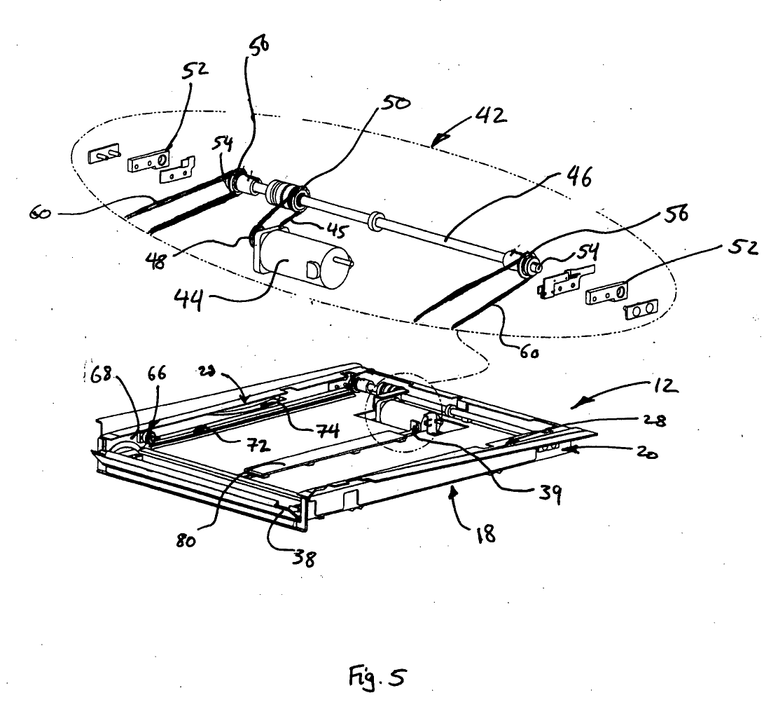

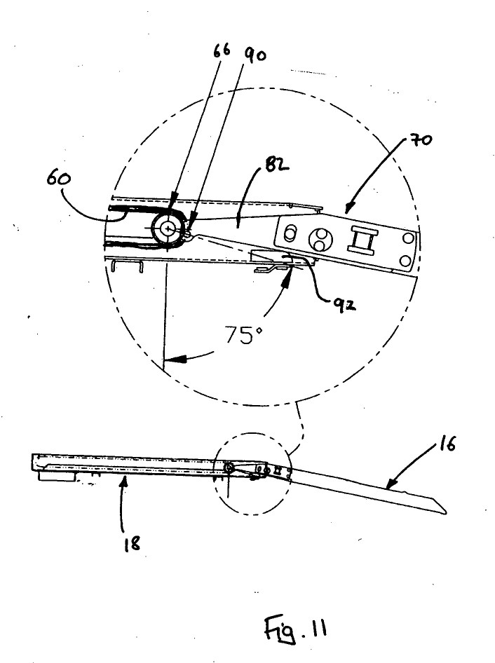

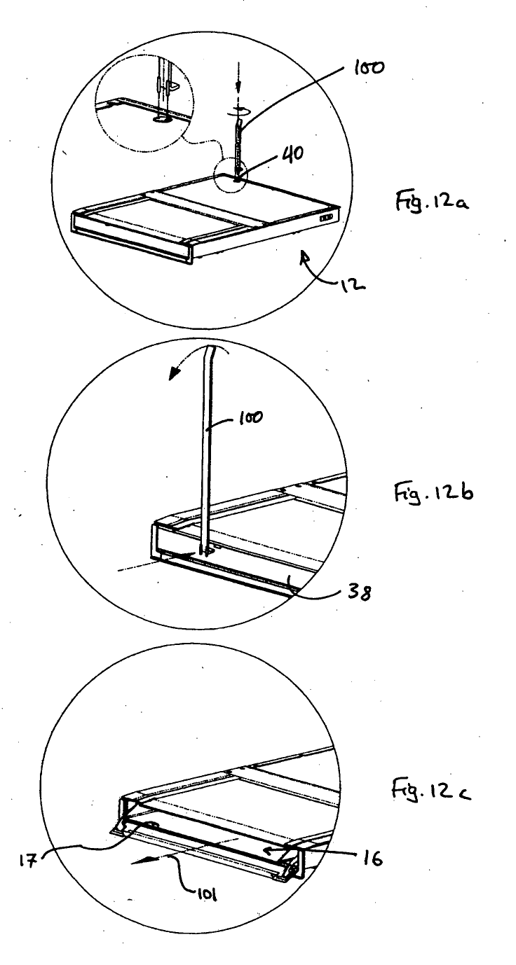

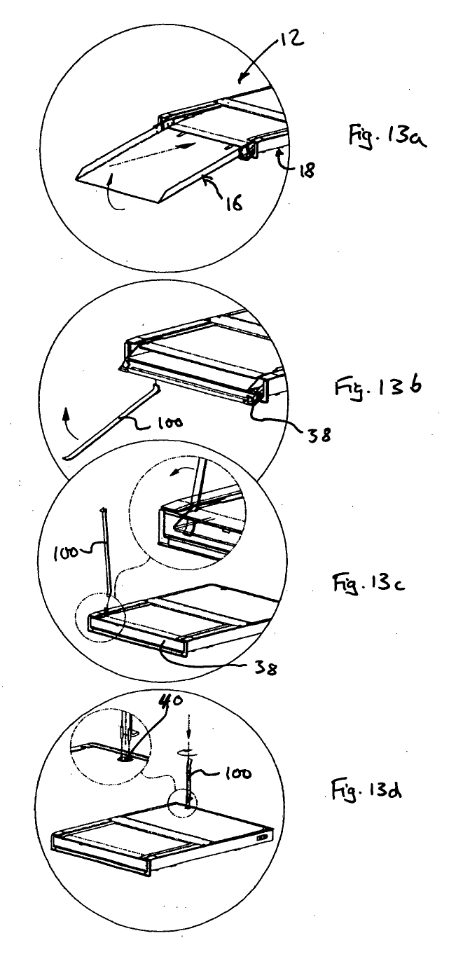

Referring to FIGS. 3 and 4, the ramp assembly 12 generally includes the ramp platform 16 which extends from the mounting structure assembly 18 that is engageable to the vehicle, preferably within the floor thereof adjacent a door as described above. The mounting structure assembly 18 includes a frame 20 within which the ramp platform 16 is received when disposed in its retracted position, as depicted in FIG. 4, wherein the ramp platform is fully stowed and enclosed within the mounting structure. To an upper side of the frame 20 is fastened a rear ramp floor panel 22 and a pivoting forward transition floor panel 24, which together enclose the mounting structure assembly 18. These floor panels are preferably fastened to the frame 20 using removable fasteners such as screws or bolts, such that access to the internals of the structure is enable for maintenance or repair purposes. The two floor panels 22 and 24 are separated by a fixed plate section 26 transversely extending between the two opposed sides 28 of the frame 20. Side panels 27 extend forward from the transverse plate 26 on either side of the frame, and generally cover and protect the lateral components of the drive mechanism for the ramp platform which will be described in further detail below. FIG. 3 shows the ramp platform 16 in the fully deployed position, wherein the ramp platform is extended outwards from the mounting structure and has pivoted downwards from the vehicle such that a remote outer end 17 of the ramp platform is disposed adjacent the ground level surrounding the vehicle (as depicted in FIG. 2). The forward transition floor panel 24 pivots downward at the forward free end 25 thereof, such that when the ramp platform 16 is deployed, as depicted in FIG. 3, a relatively smooth transition is provided between the upper surface 34 of the ramp platform 16 and the upper surface 36 of the transitional floor panel 24. Thus, a wheelchair user going up the ramp can smoothly roll form the ramp platform 16 onto the floor panels 24 and 22 of the mounting structure assembly 18, or conversely from the floor panels 22,22 onto the ramp platform 16 when going down the ramp. The ramp assembly 12 therefore is preferably disposed within a correspondingly shaped recess defined within the floor of the vehicle, such that when the ramp platform is not in use (i.e. is retracted as shown in FIG. 4) the floor panels 24 and 22 of the mounting structure assembly 18 form the floor section of the vehicle in front of a door therein. The frame 20 encloses the rear end 30 of the mounting structure, however the forward end 32 thereof is open such that the ramp platform 16 can extend outward therefrom when deployed. The open forward end 32 of the mounting structure assembly 18 can be enclosed by a pivoting door 38 which opens to allow the ramp assembly to be extended through the forward opening of the mounting structure assembly 18, and is closed again when the ramp platform 16 has been fully retracted into is stowed position within the mounting structure and therefore within the vehicle. A decoupling member 40 extends through a corresponding opening defined in the rear floor panel 22. As will be described in further detail below with reference to FIGS. 12a to 13d, the decoupling member 40 permits the drive mechanism to be disconnected or decoupled from the ramp platform such that it can be manually deployed or retraced if necessary. Thus, this safety feature ensures that the ramp can always be extended and stowed away if necessary, even if a problem occurs which renders the remotely actuated drive mechanism inoperable.

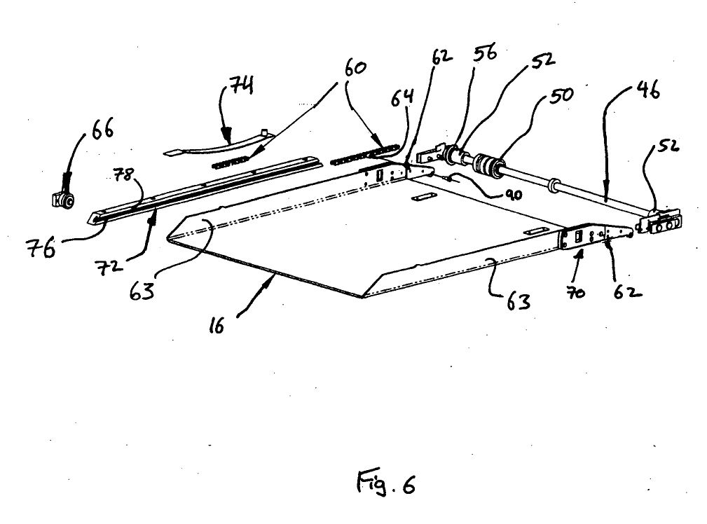

Referring now to FIGS. 5 and 6, the drive mechanism 42 of the ramp assembly 12 is operable to displace the ramp platform 16 thereof between the retracted position and the fully deployed position, and is preferably remotely actuated by a driver or passenger of the vehicle using a control switch. The drive mechanism 42 is completely disposed within the mounting structure 18, and includes a bidirectional electric motor 44 which drives a drive shaft 46, the drive shaft 46 being transversely mounted within the mounting structure 18 at the rear thereof. A pinion drive sprocket 48 on the motor output shaft is engaged with a driven sprocket 50 fixed to the drive shaft 46 via a flexible transmission element 45 such as a toothed belt or a chain drive. Preferably, as with the main pair of flexible transmission elements 60 described below, the shorter flexible transmission element 45 is a drive chain. The drive shaft 46 is preferably rotatably supported in bearing elements 52 which support both ends 54 of the drive shaft 46. Near each end 54 of the drive shaft 46 is provided a main drive gear or sprocket 56, which drive a pair of main flexible transmission elements 60 that extended along each lateral side 28 of the frame 20 within the mounting structure 18. Preferably, these flexible transmission elements 60 are drive chains made up of a plurality of individual links, however toothed belts or other suitable flexible transmission members can alternately be used. The drive chains 60 extend along each side of the mounting structure 18 within a lateral side 28 of the frame 20 thereof, each generally lying in a plane which is perpendicular to the main planar surface 34 of the ramp platform 16 and extends in a direction parallel to the translational movement of the ramp platform as it is displaced within the mounting structure 18 during deployment.

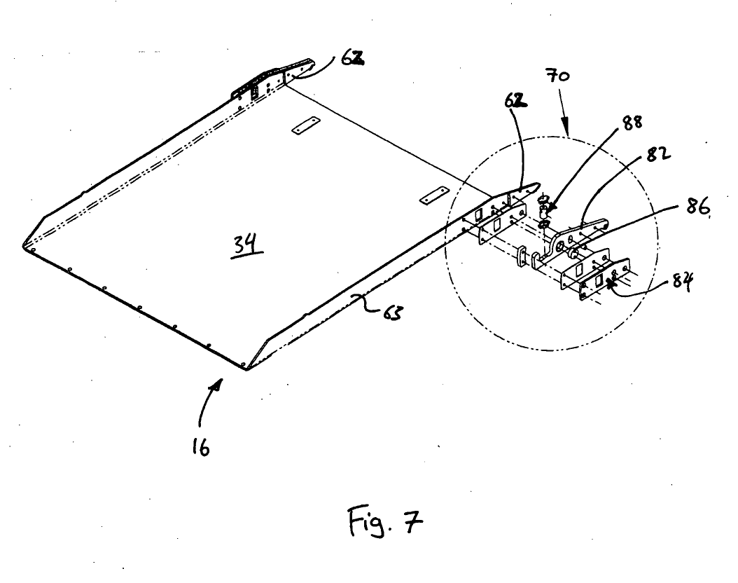

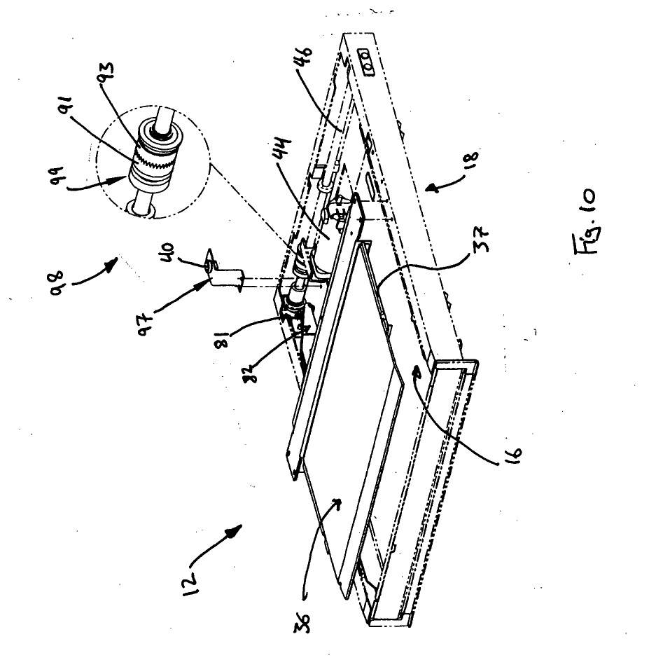

Each drive chain 60 (depicted only in part for clarity in FIG. 6) extends between the main drive sprocket 56 on each end 54 of the drive shaft 46 and a forward guide sprocket 66 disposed within mounting structure 18 on a lateral side thereof proximate the forward end. A coupling link 64 on each drive chain 60 is pivotally fastened to a support plate member 82 of the ramp platform's compensation system 70 (best seen in FIG. 6) by a shoulder bolt 90. The compensation system 70 interconnects the ramp platform 16 with the drive chains 60, at near a rearward mounting bracket 62 thereof, and provides a biased pivotal link between the mounting brackets 62, disposed on the rearward ends of the sides 63 of the ramp platform 16 as best seen in FIG. 7, and the support plate member 82 engaged to the drive chains 60. Thus, the ramp platform 16 is able to pivot downwards once the pivotal attachment point between the chain coupling link 64 and the ends of the support plate member 82 (interconnected by the shoulder bolt 90) reaches the forward guide sprocket 66, a shown in FIG. 11. The fixed location of the forward guide sprocket 66 is thus selected to be a predetermined distance from the open end of the mounting structure 18, whereby the ramp platform 16 has been fully projected outwards therefrom and the arcuate path followed by the aforementioned pivotal link at the shoulder bolt 90 as it travels around the forward guide sprocket 66 helps to rotate the ramp platform 16 downwards from the mounting structure 18 and into contact with the ground level next to the vehicle.

A door actuating mechanism is provided to ensure that the hinged outer door 38 of the mounting structure 18 opens and closes when the ramp platform 16 is deployed and retracted respectively. Particularly, a door closing actuator 39 extends below the ramp platform, and is interconnected with the door 38 at a forward end and has an upstanding rear portion which comes into contact with the rear of the ramp platform when retracted completely within the mounting structure, thereby pulling the door closed behind the ramp platform once it reaches the rear of the mounting structure opening. As the driving mechanism displaces the ramp platform outwards for deployment, the door actuator 39, which is forwardly biased, slides forward once the rear surface of the ramp platform is no longer forcing it rearward, thereby pushing on the door 38 to open it. Accordingly, no complex pins or hooks are required on the outer ends of the door 38 itself nor corresponding latching mechanism at the open end of the mounting structure. This simplifies the door actuation, and eliminates potentially dangerous projections which could harm users.

As best seen in FIG. 7, the compensation system 70 provides a biased interconnection between the ramp platform 16 and the fixed mounting structure 18 of the ramp assembly 12. This permits the ramp platform 16, when deployed, to be able to accommodate varied surface conditions and/or elevation levels of the ground onto which the ramp extends. The pivoting and compensation system 70 will be discussed in further detail below.

The forward guide sprockets 66 are each fixed to an inner surface 68 of the lateral sides 28 of the mounting structure's frame 20. Thus, the drive chains 60 extend fore-aft in substantially parallel vertical planes, one on either side of the ramp platform 16 and within the mounting structure 18. The chains 60 are guided by elongated guide rails 72 fastened to the inner surfaces 68 and which extend a majority of the distance between the rear drive gear 56 and the forward guide sprocket 66. The guide rails 72 define an elongated slot 76 which extends the full length thereof, and within which the lower run of the chain 60 is received. The inner surfaces 78 of the two opposed guide rails 76 also serve as lateral guide surfaces for the sliding ramp platform 16, which fits therebetween. Although various materials can be used for the guide rails 72, they are preferably composed of a relatively wear resistant plastic such as high density polyethylene. Upper chain guides 74 descend slightly into the upper run of the chain to help guide the chain and to help reduce chain slap by ensuring a slight tension is maintained therein.

As both lateral edges of the ramp platform 16 are simultaneously driven by the pair of flexible transmission elements 60 which, regardless of whether the ramp platform 16 is being deployed or retracted, pull the sides of the platform, via the rear mounting brackets 62, in the desired translational direction within the mounting structure 18. This ensures that the drive mechanism 42 significantly limits the tendency of the ramp platform 16 to jam within the guide surfaces of the mounting structure 18, as the ramp platform cannot easily become skewed between the opposed lateral edges of the mounting structure. The ramp platform 16 is supported within the mounting structure 18 on a central guide member 80 which provides a lower guide surface on which the ramp platform is free to slide when moving between the retracted and deployed positions. Lateral guide surfaces for the ramp platform are provided, as noted above, by the inner surfaces 78 of the side guide rails 72.

Referring now to FIG. 7 and FIG. 11, the mounting brackets 62 disposed on the rearward ends of the sides 63 of the ramp platform 16 are each engaged to a compensation system 70 which interconnects the drive chains 60 and the ramp platform. The compensation system 70 includes a biasing member which allows the ramp platform to be able to adjust to varied elevations of the ground that the ramp contacts when the ramp platform 16 pivots downwards once it has been translated outward from the mounting structure 18 by the drive mechanism 42. Particularly, the compensation system 70 comprises a main support plate member 82 which is sandwiched between the rear mounting bracket 62 of the platform 16 and an outer plate member 84, the main support plate member 82 being pivotal relative thereto about the pivot member 86 which is fixed both to the outer plate member 84 and the platform's rear mounting bracket 62. Preferably, thin friction reducing elements (made of high density polyethylene for example) are disposed between the outer plate member 84 and the support plate member 82, and between the support plate member 82 and the platform mounting bracket 62. A biasing member 88, preferably but not necessarily a polymer spring made of urethane for example, is mounted with the compensation system 70 between the pivoting support plate member 82 and the fixed surrounding mounting structure composed of the outer plate 84 of the sides of the platform itself. As seen in FIG. 7, the biasing member 88 is normally oriented substantially perpendicular to the upper surface 34 of the ramp platform 16 when the ramp platform and the support plate member 82 are aligned (i.e. note pivotally displaced relative to their normally aligned position). The biasing member 88 is disposed forward of the pivot 86 between the support plate member 82 and the ramp platform. As such, the biasing member 88 is compressible to react against a pivot of the ramp platform 16 relative to the support plate member 82 which is pivotally linked to the drive chains 60. This enables the ramp platform to be able to accommodate angular variations when it pivots downwards from the mounting structure 18. Although the geometry of the ramp assembly 12 is preferably pre-configured for being normally a given height above the ground level, the biased pivotal nature of the compensation system 70 permits the ramp platform be able to be deployed onto various ground levels (such as a curb or sidewalk for example which is higher than the road or street level). As seen in FIG. 11, a pivot block 92 fixed to the horizontal base of the mounting structure at the open forward end thereof acts as a fulcrum point for the support plate member 82 as the ramp platform 16 pivots downwards from the mounting structure 18 during deployment.

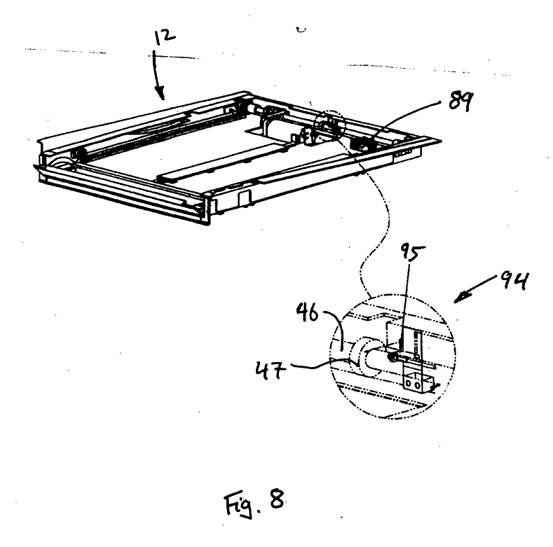

Referring to FIG. 8, the ramp assembly 12 includes an obstacle detection system 94 which is incorporated within the drive mechanism 42, and which includes a sensing means 95 for detecting one of deflection, translational displacement or strain of the drive shaft 46, and an electrical control unit 89 which is disposed in electrical communication with the sensing means 95 (and all other sensors disposed in the ramp assembly) for receiving output signals therefrom. Preferably, the sensing means 95 is a sensor operable to detect deflection of the drive shaft 46, by detecting when a collar 47 fixed to the drive shaft 46 is no longer in proximity to the sensor, which occurs when the drive shaft is sufficiently bowed by deflection. As the opposed ends of the drive shaft 46 are retained in place, any deflection induced in the drive shaft as a result of the torque from the motor acting on the drive gear 50 tends to bow the drive shaft outwards in the middle. Thus, when sufficient resistance is encountered by the extending ramp platform, the ends of the drive shaft are prevented from turning while the drive chain 45 continues to apply torque to the center of the drive shaft 46 between the stalled ends, thus causing the drive shaft to deflect. When a predetermined amount of deflection has occurred, selected by calibration of the sensor, the sensor detects that the collar 47 is no longer in view and sends a signal to the control unit 89 to stop the motor. The control unit 89 is thus also disposed in electrical communication with the motor 44 of the drive mechanism 42, such that the motor is at least stopped when an output signal from the sensing means is above a predetermined threshold limit. Preferably, the control 89 also then reverses direction of the motor 44 such that, once an obstacle has been encountered, the ramp platform 16 retracts back into the mounting structure. The threshold limit is preferably chosen relatively low such that no harm can come to a person standing in the way of the extending ramp which may obstruct the full deployment thereof. It is to be understood that other embodiments of the sensing means 95 which measure deflection in the drive shaft, such as a strain gauge mounted to or within the drive shaft and which measures undue deflection thereof.

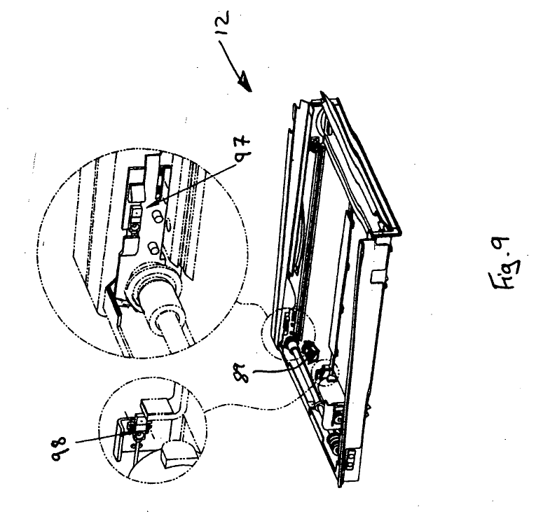

As seen in FIG. 9, the ramp assembly 12 may also include various other sensors, all in communication with the main control unit 89, such as proximity sensors 97 and 98 which respectively detect whether the ramp platform is deployed and retracted. These sensors are used to determine in which direction the motor 44 is driven, when it receives an actuation signal from a remote actuation switch used to operate the drive mechanism 42. The actuation signal may simply be a power signal, the actuation switch merely closing a power supply circuit to the motor 44. Particularly, if the sensor 97 registers that the ramp platform is deployed when the actuation signal is received by the motor 44, then the motor is driven in reverse to pull the ramp platform back into the mounting structure 18 for stowage thereof, thus retracting the ramp. If, however, the sensor 98 registers that the ramp platform is already fully retracted within the mounting structure 18 when the actuation signal is received by the motor, then the motor is driven forwards to deploy the ramp platform 16 outwards from the mounting structure 18. Preferably, the remote switch is disposed within the bus 10, either within reach of the driver thereof or proximate a door such that a passenger can operate it, which activates the electric motor 44 of the drive mechanism to either deploy and or retract the ramp platform 16 of the ramp assembly 12.

Referring to FIG. 10, the ramp assembly 12 also preferably includes a manual disengagement mechanism 98 which permits the drive shaft 46 to be split into two de-couple portions, such that the ramp platform 16 can be manually deployed and retraced without the use of the motor 44 of the drive mechanism 42. Particularly, the manual actuator 97 includes a rotating screw-type decoupling member 40 which, when rotated, acts to separate the two intermeshing gear 91 and 93 of the drive transmission 99. Once the normally engaged gears 91 and 93 have been split apart, the drive shaft 46 is thus split into two portions, and the ramp platform 16 can be manually pulled out from the mounting structure 18 without the use of the motor 44. This ensures that the ramp can always be extended and stowed away if necessary, even if a problem occurs which renders the remotely actuated-drive mechanism and/or motor inoperable.

Also, as best seen in FIG. 10, the lateral edges of the transition floor 36 are provided with friction reduction strips 37 which are adapted to slide along the inclined rear surfaces 81 of the mounting plate members 82 which comprise part of the compensation system 70 that interconnects the ramp platform 16 and the chains 60 of the drive mechanism. Thus, the transition floor 36 is gradually lowered as the mounting plate members 82 rear the forward most point of their displacement, namely at the end of the translational movement of the ramp platform just before it pivots downwards to contact the ground. Similarly, in the reverse direction, as the ramp platform begins its return translation back into the mounting structure, the strips 37 on the lateral edges of the transition floor 36 slide upwards along the inclined surfaces 81 of the mounting plate members 82, thereby raising the transition floor 36 back to its horizontal position (when the ramp is retracted) from the inclined position (assumed when the ramp is fully deployed).

FIGS. 12a-12c show the steps involved with the manual deployment of the ramp platform 16 using the manual disengagement mechanism 98 described above. A tool 100 may be used, however a standard screwdriver or similar tool will also sufficient. The tool 100 is inserted, as depicted in FIG. 12a, into the screw-type decoupling member 40 of manual actuator 97 and rotated to decouple the meshed gears 91 and 93 of the drive shaft 46. As seen in FIG. 12b, the tool is then used to lever open the frontal door 38 of the ramp assembly. The outer end 17 of the ramp platform 16 is then exposed, and can be manually grabbed by a user and pulled, to withdraw the ramp platform outwards from the mounting structure 18 in direction 101. Once the full translational travel of the ramp platform is reached, the user can simply let go of the ramp platform, which will then fall towards the ground level by gravity. FIGS. 13a-13d depict the same steps which are performed in reverse order when the ramp platform 16 is to be manually retracted.

The embodiments of the invention described above are intended to be exemplary. Those skilled in the art will therefore appreciate that the forgoing description is illustrative only, and that various alternatives and modifications can be devised without departing from the spirit of the present invention. Accordingly, the present is intended to embrace all such alternatives, modifications and variances which fall within the scope of the appended claims.

1. A ramp assembly for use in a vehicle to provide access thereto by users having reduced mobility, the ramp assembly comprising:
a ramp platform displaceable relative to a mounting structure adapted for engagement to said vehicle said ramp platform being displaceable between a retracted position wherein said ramp platform is stowed within said mounting structure and a deployed position; and
a drive mechanism disposed within said mounting structure and operable to displace said ramp platform between said retracted and said deployed positions, said drive mechanism having at least a drive shaft and a bidirectional motor unit selectively actuable to rotate said drive shaft in a first direction for deploying said ramp platform and a second opposed direction for retracting said ramp platform, said drive mechanism including a pair of flexible transmission elements each interconnecting said drive shaft with a lateral edge of said ramp platform for displacement thereof relative to said mounting structure.

2. The ramp assembly as defined in claim 1, wherein said flexible transmission elements comprises one of a drive chain and a drive belt.

3. The ramp assembly as defined in claim 1, wherein each of said pair of flexible transmission members is driven by a drive gear fixed to said drive shaft.

4. The ramp assembly as defined in claim 3, wherein said drive gears are disposed adjacent opposed ends of said drive shaft.

5. The ramp assembly as defined in claim 1, wherein said drive shaft is transversely mounted within said mounting structure, and rotatable about an axis substantially perpendicular to a direction of travel of said ramp platform within said mounting structure.

6. The ramp assembly as defined in claim 1, wherein said motor unit drives said drive shaft via a third flexible transmission member.

7. The ramp assembly as defined in claim 6, wherein said third flexible transmission member is driven by a drive gear of said motor unit and drives a transmission gear fixed to said drive shaft.

8. The ramp assembly as defined in claim 7, wherein said transmission gear is disposed on said drive shaft between outer drive gears fixed to the drive shaft proximate the extremities thereof, said outer drive gears engaging said pair of flexible transmission members.

9. The ramp assembly as defined in claim 1, further comprising an obstacle detection system operable to prevent full deployment of said ramp platform when an obstacle obstructs a travel path of the ramp platform.

10. The ramp assembly as defined in claim 9, wherein said obstacle detection system includes a sensing means for detecting deflection of said drive shaft generated when said ramp platform contacts said obstacle.

11. The ramp assembly as defined in claim 10, wherein said obstacle detection system further comprises a control unit in communication with said sensing means for receiving output signals therefrom, said control unit being operable to reverse the direction of said motor unit when said output signal is above a predetermined threshold limit.

12. The ramp assembly as defined in claim 1, wherein said ramp platform includes a compensation system having a biasing member disposed between said ramp platform and a pair mounting brackets to which said flexible transmission members are fastened.

13. The ramp assembly ass defined in claim 1, further comprising a manual disengagement mechanism having a decoupling member operable to uncouple said motor unit from at least one of said flexible transmission elements, such that said ramp platform is manually retractable and deployable without the use of said motor unit.

14. A vehicle having a ramp assembly for providing access thereto by users having reduced mobility, the vehicle having a passenger compartment defining an inner floor and a door providing access to the passenger compartment, the ramp assembly comprising:
a mounting structure being disposed within said floor of the vehicle in alignment with said door;
a ramp platform displaceable relative to the mounting structure between a retracted position wherein said ramp platform is stowed within said mounting structure and a deployed position extending outwards from said vehicle; and
a drive mechanism disposed within said mounting structure, said drive mechanism having a pair of gear driven flexible transmission elements each interconnecting a lateral edge of said ramp platform with a motor unit operable to move said ramp platform relative to said mounting structure between said retracted and said deployed positions.

15. A ramp assembly for use in a vehicle to provide access thereto by users having reduced mobility, the ramp assembly comprising:
a mounting structure adapted for engagement to said vehicle beneath a door thereof;
a ramp platform displaceable relative to the mounting structure between a retracted position wherein said ramp platform is stowed within said mounting structure and a deployed position;
a drive mechanism disposed within said mounting structure and operable to displace said ramp platform between said retracted and said deployed positions; and
an obstacle detection system including a sensing means for detecting deflection of said drive shaft and a control unit in communication with said sensing means which receives output signals therefrom, said control unit being operable to reverse a direction of said drive mechanism when said output signal is above a predetermined threshold limit, wherein said predetermined threshold limit corresponds to an amount of deflection generated in said drive shaft when said ramp platform contacts an obstacle which is obstructing full deployment thereof from said mounting structure.

16. The ramp assembly as defined in claim 15, wherein said drive mechanism includes at least a drive shaft and a motor unit actuable to rotate said drive shaft in a first direction for deploying said ramp platform and a second opposed direction for retracting said ramp platform, said drive shaft being transversely oriented within said mounting structure.

17. The ramp assembly as defined in claim 16, wherein said drive mechanism includes a pair of flexible transmission elements each interconnecting said drive shaft with a lateral edge of said ramp platform.

18. The ramp assembly as defined in claim 17, wherein each of said pair of flexible transmission members is driven by a drive gear fixed to said drive shaft.

19. The ramp assembly as defined in claim 18, wherein said drive gears are disposed adjacent opposed ends of said drive shaft.

20. The ramp assembly as defined in claim 16, wherein said motor unit drives said drive shaft via a third flexible transmission member.

21. The ramp assembly as defined in claim 20, wherein said third flexible transmission member is driven by a drive gear of said motor unit and drives a transmission gear fixed to said drive shaft.

22. The ramp assembly as defined in claim 21, wherein said transmission gear is disposed on said drive shaft between outer drive gears fixed to the drive shaft proximate the extremities thereof, said outer drive gears engaging said pair of flexible transmission members.

23. The ramp assembly as defined in claim 15, wherein said ramp platform includes a compensation system having a biasing member disposed between said ramp platform and a pair mounting brackets to which said flexible transmission members are fastened.

24. The ramp assembly ass defined in claim 15, further comprising a manual disengagement mechanism having a decoupling member operable to uncouple said motor unit from at least one of said flexible transmission elements, such that said ramp platform is manually retractable and deployable without the use of said motor unit.

25. A drive mechanism for use with a retractable vehicle ramp assembly which provides access to a vehicle for users having reduced mobility, the drive mechanism comprising at least one drive shaft transversely mountable within the ramp assembly and a bidirectional motor unit selectively actuable to rotate said drive shaft in a first direction for deploying said ramp platform and a second opposed direction for retracting said ramp platform, a pair of drive gears being fixed to the drive shaft proximate opposed lateral ends thereof, and a pair of flexible transmission elements each being driven by one of said drive gears and having a coupling link adapted for engagement with one lateral edge of a ramp platform of said ramp assembly.
